(19) United States
(12) Patent Application Publication
(10) Pub. No.: US 2009/0041910 A1
(43) Pub. Date: Feb. 12, 2009

(54) MULTI-PIECE FEEDING BOWL

(75) Inventors: Kevin Rabinovitch, Franklin, TN (US); Jason Friedland, Franklin, TN (US); Diana L. Ortiz Maldonado, White Plains, NY (US); Jane Rabinovitch, Franklin, TN (US); Gary N. Chisholm, Rancho Palos Verdes, CA (US); Frank Shields, Nashville, TN (US)

Correspondence Address: FULBRIGHT & JAWORSKI, LLP, 1301 MCKINNEY, SUITE 5100, HOUSTON, TX, 77010-3095, US

(73) Assignee: MARS INCORPORATED, McLean, VA (US)

(21) Appl. No.: 11/835,719

(22) Filed: Aug. 8, 2007

(51) Int. Cl. B65D 85/00; A01K 5/00; B65D 81/24

(52) U.S. Cl. 426/115; 119/61.5

(57) ABSTRACT

The present invention is directed to a multi-piece animal food server including two separate components, a feeding component containing a unitary pre-packaged serving of animal food and a support component configured to hold at least one feeding component. The present invention is also directed to a sanitary, quick and easy method of feeding an animal that utilizes the multi-piece animal food server.

### TECHNICAL FIELD

The present invention is directed to a multi-piece animal food server and more particularly to a multi-piece animal food server having at least one feeding component containing a pre-packaged serving of animal food and a support component configured to hold at least one feeding component.

### BACKGROUND OF THE INVENTION

Feeding an animal, such as a dog or cat, can be a time-consuming and unpleasant task. First, the animal owner must open a container of animal food and utilize family kitchen utensils to completely transfer the animal food from the container to the animal's bowl. After the animal has finished feeding, the animal owner must wash out the bowl with soap and water to avoid the unwanted accumulation of food in the animal's bowl. The accumulation of animal food in a bowl can be an unpleasant sight. Additionally, it can give rise to foul smells and attract unwanted pests. The disagreeable chores of transferring animal food to the bowl and washing the bowl after each use cause many animal owners to feed their animals only dry animal food. This compensating behavior of the consumer points to a need for a package design that isolates the food container and feeding surface from the support structure.

The general manufacturing process for animal food entails processing sources of protein, carbohydrates and fat typically found in animal food. These ingredients are mixed with the other ingredients, and if the recipe requires, the mixture is shaped into appropriate forms. The finished product is filled into containers. Semi-moist and dry animal foods are made shelf stable prior to packaging. Moist animal foods are sealed in their containers to reduce the oxygen content and prevent spoilage of fats in the food. The animal food is sterilized by passing the containers through a retort or heating chamber in which the containers are heated to a high temperature of about 250° F. for several minutes. Retort sterilization uses superheated steam to cook food while killing pathogens. The cooking temperatures and times vary depending on the contents, steam pressure, and container shape and size. The containers are then cooled, dried, labeled, and shipped to distributors.

It would be advantageous to provide, in accordance with the illustrated preferred embodiment of the present invention, a multi-piece animal food server including primarily two components that can be manufactured separately, a feeding component containing a unitary pre-packaged serving of animal food and a support component configured to hold the feeding component.

### BRIEF SUMMARY OF THE INVENTION

The present invention is directed to a multi-piece animal food server that includes at least two separate components, a feeding component and a support component. The feeding component contains a pre-packaged serving of animal food. The support component is configured to hold at least one feeding component.

The feeding component can be any shape and size that fits within at least one support component. Preferably, the feeding component includes a container having a bottom and a side wall, the bottom edge of the side wall connects to the perimeter of the bottom forming a cavity. A cover seals the serving of animal food within the cavity of the container. A horizontal projection may extend outwardly from the top edge of the side wall. The container can be any shape and size.

The support component can be any support structure that holds at least one feeding component. Preferably, the support component includes a surrounding side member, a top surface, and an opening in the center of the top. The opening of the support structure is configured so that at least one container can be inserted therein.

Alternatively, the support component can generally be rectangular in shape, includes an indentation configured to hold the food component and a leg at each corner of the support component The support component further includes a pair of clip members positioned along two opposing and parallel sides of support

The container and support component are preferably combined by a drop-in-place method. According to this method, the container is inserted into the opening of the component to create the multi-piece animal food server. However, other methods such as clip-in-place, snap-in-place, friction fit, the use of adhesives, welds, magnets, Velcro and wax can be used to combine the container and component.

The present invention is also directed to a clean, fast and convenient method for feeding a animal which utilizes the multi-piece animal food server described above. Any feeding and support component can be employed, but preferably, a unitary pre-packaged feeding component and a support component are used. Accordingly, the animal owner inserts the container into the opening of the support component for consumption of the animal food by a animal. The animal owner then removes the cover form the container to expose the animal food contained within. When the animal is finished feeding, the animal owner simply removes the empty or partially empty container from the support component and disposes of the used container. The support component can be reused by the animal owner as many times as desired since the food does not come in contact with the support component.

The foregoing has outlined rather broadly the features and technical advantages of the present invention in order that the detailed description of the invention that follows can be better understood. Additional features and advantages of the invention will be described hereinafter which form the subject of the claims of the invention. It should be appreciated by those skilled in the art that the conception and specific embodiment disclosed can be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a perspective view of an embodiment of a multi-piece animal food server;

FIGS. 2A and 2B are perspective views of a container;

FIG. 3 is a perspective view of a support component;

FIGS. 4A and 4B are perspective views illustrating the drop-in-place method for the combination of the container in FIGS. 2A and 2B and the support component in FIG. 3 to form the multi-piece animal food server in FIG. 1.

FIG. 5 is a perspective view of an alternate embodiment of the feeding component of the subject invention;

FIG. 6 is a top plan view of the feeding component of FIG. 5;

FIG. 7 is a side plan view of the feeding component of FIG. 5;

FIG. 8 is a cross sectional view of FIG. 7 taken along lines 8-8;

FIG. 9 is a perspective view of an alternate embodiment of the feeding component of the subject invention;

FIG. 10 is a side plan view of the feeding component of FIG. 9 placed above the support component;

FIG. 11 is a perspective view of the feeding component of FIG. 9 in the support component;

FIG. 12 is a perspective view of an alternate embodiment of the multi-piece animal food server;

FIG. 13 is a side plan view of the multi-piece animal food server in FIG. 12; and

FIG. 14 is a cross sectional view of FIG. 13 taken along lines 14-14.

### DETAILED DESCRIPTION OF THE INVENTION

As used herein, the use of the word “a” or “an” when used in conjunction with the term “comprising” in the claims and/or the specification can mean “one,” but it is also consistent with the meaning of “one or more,” “at least one,” and “one or more than one.”

As used herein, a animal is defined as an animal, preferably a companion animal, and most preferably a dog or cat.

As used herein, retort grade material is defined as a material, or a combination of materials, that can withstand the high temperatures and pressures required during retort sterilization and also serves as a barrier to oxygen and water vapor. Retort grade material has a high heat-resistance and does not melt, degrade or become defective when subjected to retort sterilization conditions. Retort grade material provides all the barriers a food product requires to be shelf stable. A variety of co-extrusions or laminates of metals, plastics and combinations thereof are employed as retort grade material. Suitable retort grade materials for the present invention are any well known in the art. Additionally, these materials need to be food-contact approved.

As used herein, food is defined to include at least dry, semi-moist and wet animal food, drinks, snacks, treats, nutritional supplements, nutraceuticals and drugs.

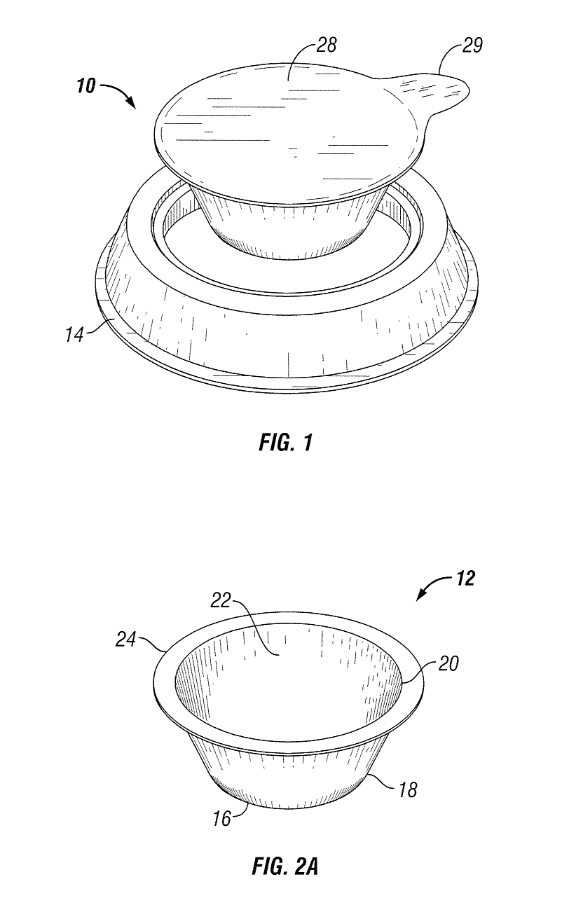

The present invention is directed to a multi-piece animal food server 10 having at least two components that can be manufactured separately, a feeding component 12 that contains a unitary pre-packaged serving of animal food and an outer support component 14 configured to hold feeding component 12 (FIG. 1). Alternatively, multiple feeding components 12 can be supplied with one support component. The two separate components 12, 14 have specific features and benefits. Each component provides considerable advantages to both consumer and manufacturer.

Feeding component 12 is composed of retort grade material and can comprise a cup, a bowl, a can, a tub, a pouch, a carton or any other suitable container known in the art of animal food manufacturing. An example of materials can include metal such as steel, aluminum, recyclable metal; plastic such as polypropylene contact layer and other multi-layered plastics. The plastics can be rigid, semi-rigid or flexible. For example, feeding component 12 can include a container having any shape and size that fits within at least one support component 14. Accordingly, a variety of different feeding components can be manufactured to meet the feeding needs of the wide range of animals in existence.

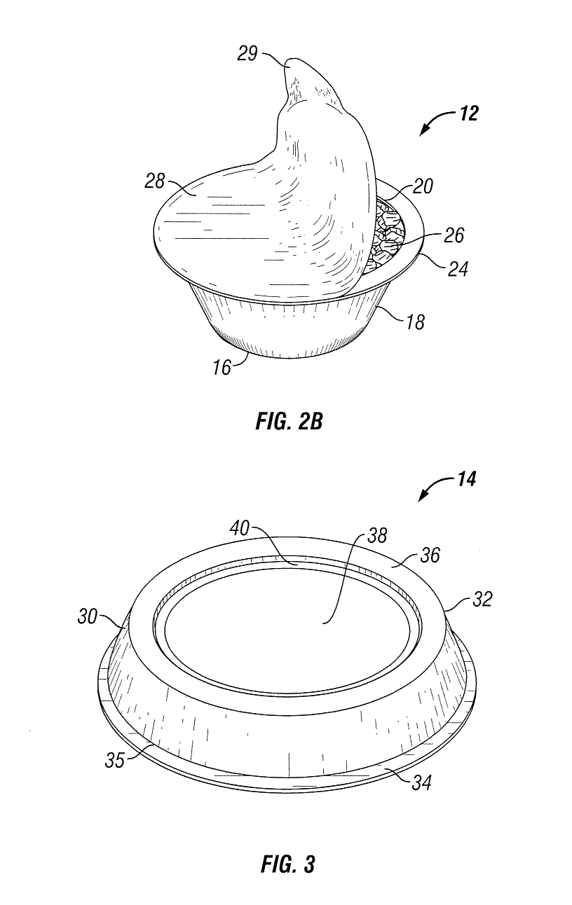

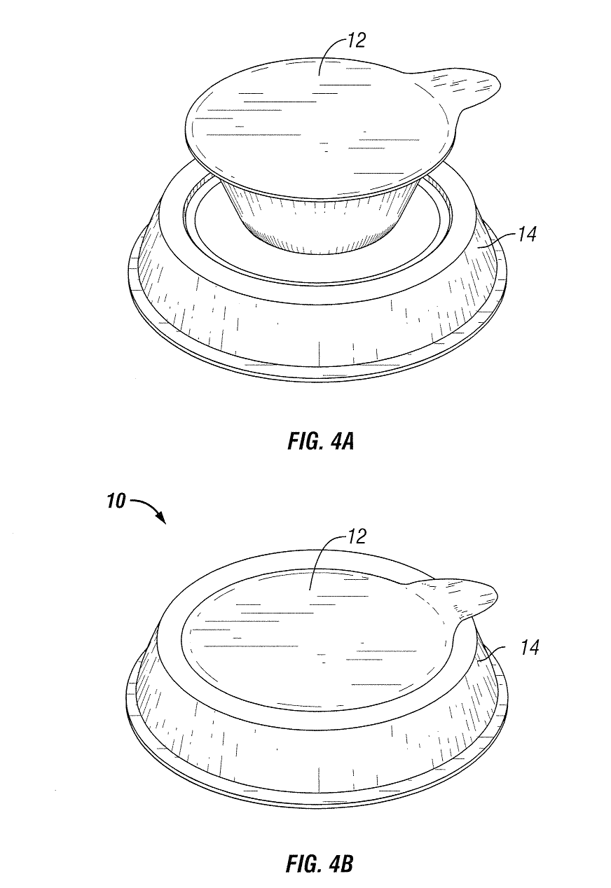

The feeding component 12 can be any shape such as circles, ovals, octagons, squares and decagons for example. However for illustrative purposes only, a feeding component comprising a container of a circular shape is seen in FIGS. 2A and 2B. Container 12 includes a bottom 16 and a circular side wall 18 forming an edge 20 and a cavity 22. A horizontally disposed projection 24 extending outwardly from edge 20 can also be included in container 12. Feeding component 12 is configured to fit within at least one support component 14 (FIGS. 4A and 4B).

Attached to the top of container 12 is a removable cover 28 that seals a unitary serving of animal food 26 within cavity 22. Cover 28 is composed of retort grade material and preferably includes a peelable lidding film having a tab 29. Cover 28 can be a peelable film, a removable lid, a removable, resealable lid, can lids, or pop-top lids. This packaging provides a convenient and easy opening feature to the consumer. However, any suitable cover such as any lid or lidding film can be used, including reclosable and re-sealing features. The size of the container 12 can vary depending upon the amount of food required for a single serving of food for the size of animal to be fed.

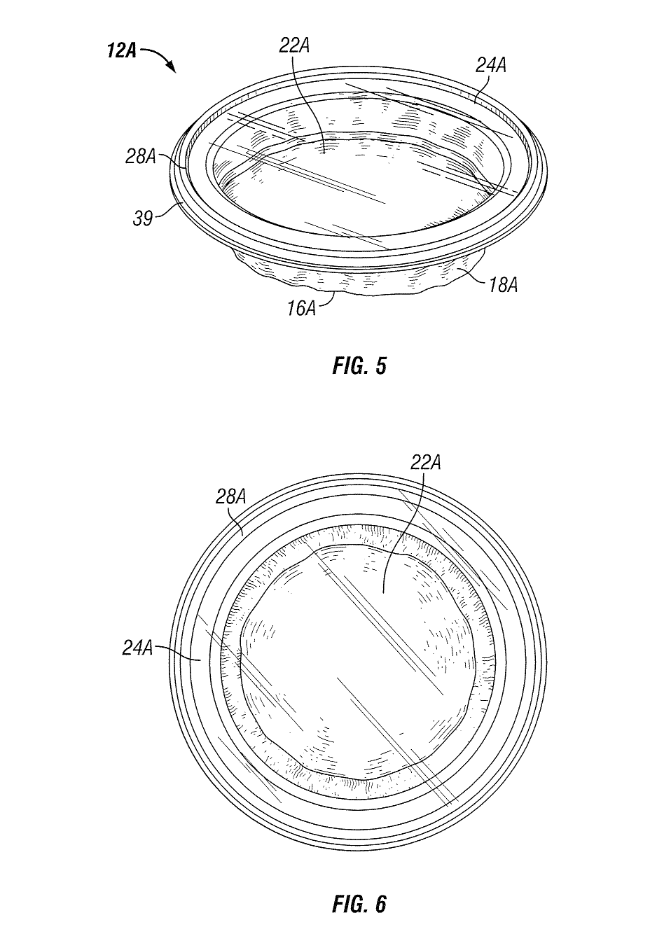

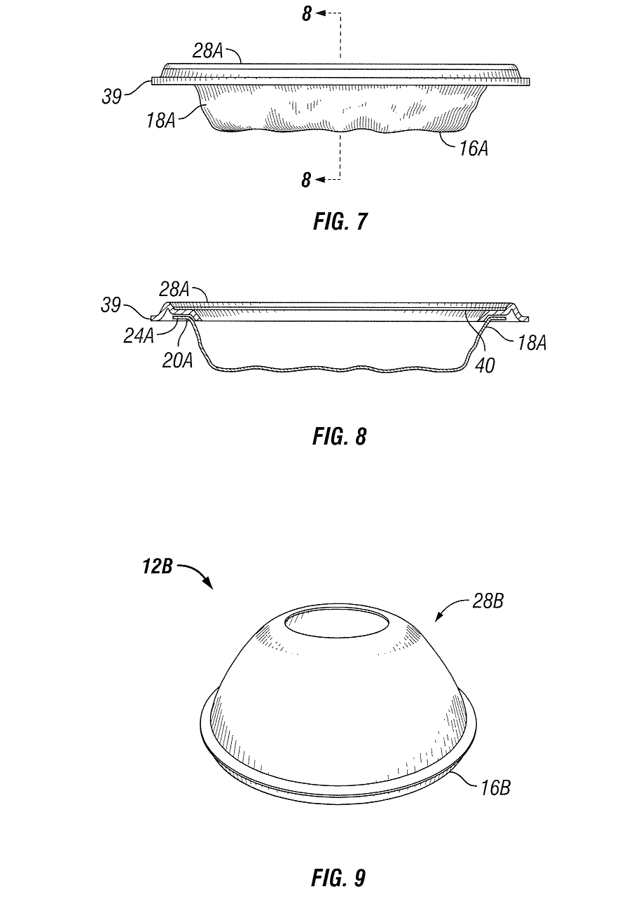

Another embodiment of the feeding component is illustrated in FIGS. 5-8. Container 12A is generally in the shape of a tub and includes a bottom 16A and a circular side wall 18A forming an edge 20A and a cavity 22A. A horizontally disposed projection 24A extending outwardly from edge 20A can also be included in container 12A. This projection would further protect the support component 14 from being contaminated with food. Feeding component 12 is configured to fit within at least one support component 14 (FIGS. 4A and 4B).

Attached to the top of container 12A is a removable cover or seal 28A that seals a unitary serving of animal food 26 within cavity 22A. Preferably, a peelable film 40 is placed over the surface of the container 12A and the removable cover 28A is placed over the film 40. Cover 28 is composed of retort grade material and preferably includes a rim 39 configured to allow the cover 28A to snap-in-place over the container 12A. This packaging provides a convenient and easy opening feature to the consumer. The cover 28A can include a reclosable feature. The size of the container 12A can vary depending the amount of food required for a single serving of food for the size of animal to be fed.

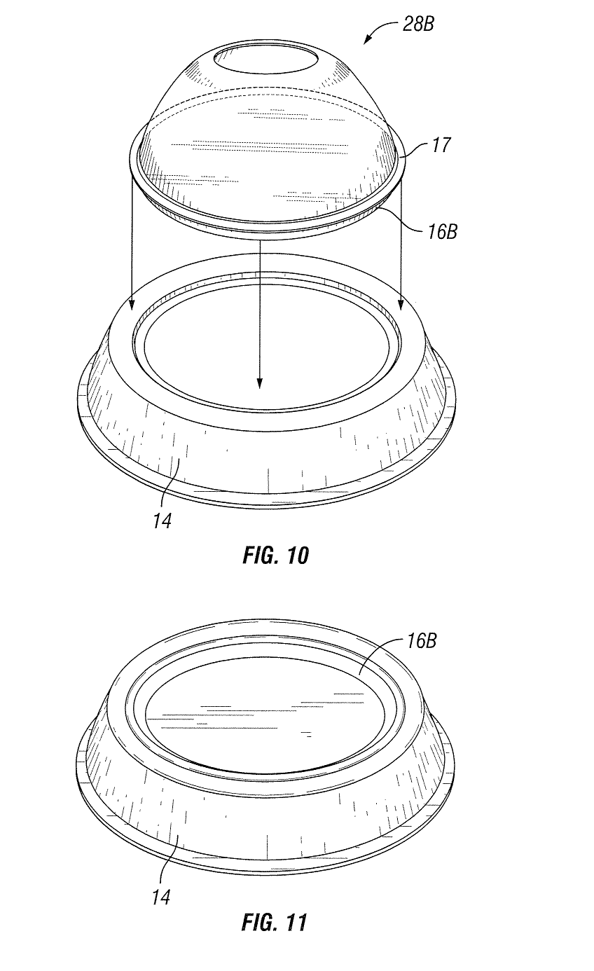

An alternate embodiment of the feeding component is shown in FIGS. 9-11. Container 12B has a bottom component 16B that is generally in the shape of a plate and a cover 28B that is generally dome shaped. The cover 28B has a peelable seal 17 over its opening and the unitary serving of the food is placed in the cover 28B. In this embodiment, the seal 17 is removed from the cover 28B and the food is deposited on the bottom component 16B which becomes an eating surface for the animal. The container 12B would likewise fit into the support component 14.

Container 12, 12A, 12B can be processed separately from support component 14. Accordingly, animal food 26 in container 12, 12A, 12B can be sterilized without needing to sterilize the support component 14. After container 12, 12A, 12B is sealed it becomes a unitary pre-packaged serving of animal food. The smaller size of container 12, 12A, 12B relative to the size of the entire disposable multi-piece animal food server 10, will permit a greater number of units to fit within the defined space of the retort at any one time. This feature of the present invention will provide a significant increase in the rate of production and, consequently, a decrease in the cost of the manufacturing process. It also provides for a reduction in the cost of the retortable materials for the entire package.

Any kind of support component 14 that holds at least one feeding component 12 can be utilized. One embodiment of a support component is illustrated in FIG. 3 in which support component 14 includes an upwardly and inwardly sloping side member 30 terminating at a top rim 32. The rim 32 includes a top surface 36. A bottom structure 34 can extend outwardly from and surround the bottom edge 35 of side member 30.

The side member 30 surrounds and defines an opening 38 that extends from the center of top surface 36 to the bottom 35 of side member 30. Opening 38 is configured to receive container 12. Optionally, a ledge 40 can extend outward from and surround opening 38 that is slightly indented relative to top surface 36 for receiving the feeding component. This indented area 40 of top surface 36 is configured to fit projection 24 of container 12 (FIGS. 4A and 4B).

The bottom edge 35 of the support component 14 or the underside of the bottom structure 34 can include a non-skid surface or be comprised of a non-skid material. This will provide a more stable support structure which minimizes sliding when the animal is feeding. The non-skid surface can be provided by tape or adhesive or a friction rubber coating. Support component 14 can also include a mounting means for affixing to a fixed object, such as a wall.

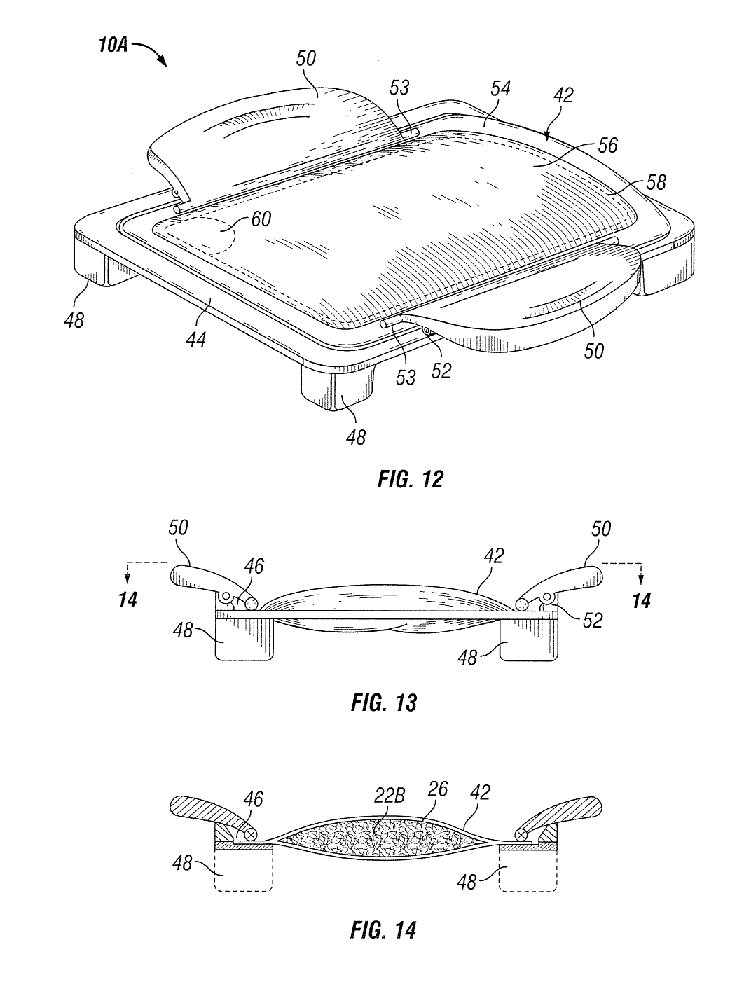

Another preferred embodiment of the multi-piece animal food server is illustrated in FIGS. 12-14. Multi-piece animal food server 10A includes a support component 44 configured to be in communication with a feeding component 42 in the form of a flexible food container such as a retortable pouch. Feeding component 42 contains a unitary pre-packaged animal food 26. The support component 44 includes an indentation 46 configured to hold the flexible food container 42 and a leg 48 at each corner of the support component 44. Support component 44 has a size and shape that accommodates the size and shape of known flexible animal food pouches that are commercially available. Preferably, component 44 is generally rectangular in shape.

Support component 44 also includes a pair of clip members 50 positioned along two opposing and parallel sides of component 44. Clip members 50 each have a bottom edge 52 that is attached to each of the opposing and parallel sides of component 44. The top edge 53 of each clip member 50 opens to receive and hold a portion of the feeding component 42. Legs 48 can include a non-skid surface or be comprised of a non-skid material. This will provide a more stable support structure which minimizes sliding when the animal is feeding. The non-skid surface can be provided by tape or adhesive or a friction rubber coating.

Feeding component 42 includes a cavity 22B and a border portion 54 that surrounds the outer perimeter of the container 42. It is the border portion 54 that the clip members 52 clamp on to in order to hold container 42 in the support component 44. (FIGS. 13-14) Container 42 also includes a removable top portion 56 that can be peeled away in order to expose the unitized pre-packaged animal food 26 contained with the feeding container 42. A score line 58 and a tab 60 assist in the removal of the removable top portion 56 of container 42.

Alternatively, container 42 can be secured to the support component 44 by other means, including pegs or hooks that protrude from component 44 to interface with a corresponding hole in the border portion 54 of the container 42. Other securing means are contemplated.

Support component 14, 44 can be composed of any suitable material known in the art. Non-limiting examples of suitable materials are plastic, cardboard, paper, glass, ceramic, PLA (Polylactide), molded fiber board, sustainable or recycled packaging, metal, edible food, wire frame and wood or combinations thereof. Preferably, support component 14, 44 is constructed of an inexpensive material. This will result in reduced manufacturing costs which can benefit both consumer and manufacturer.

A dishwasher safe material can be used to construct support component 14, 44. This provides the added feature of convenient and easy cleaning to the consumer. After a number of uses, support component 14, 44 might get smeared with animal food, the animal's saliva or other undesired substances. The animal owner can simply place support component 14, 44 in a dishwasher to be cleaned. Alternatively, the container 12, 12A can include a lip or flange to protect support component 14 from the food.

Recyclable material can also be employed to make support component 14, 44. Recyclable materials are well known in the art. This can appeal to consumers concerned with environmental issues.

Support component 14, 44 can be clear or the natural color of the material used to make it. Support component 14, 44 can be manufactured in any of the vast number of colors and decor as desired. One or more designs can be used to decorate support component 14 to increase the aesthetic appeal of the product. Non-limiting examples of such designs are words, letters, swirls, lines, circles, hearts, bones, dogs and cats. Designs can also include a holiday theme object or character such as a snowman, a ghost or a turkey. Support component 14 can also be custom made to a particular consumer's desires.

Any support structure having any shape and size that holds at least one feeding component 12, 12A, 12B, 42 can be employed. Accordingly, numerous support components can be manufactured to meet the needs of a broad range of animals and the preferences of a wide variety of animal owners. Support component 14, 44 can include any support structure such as a component, a receptacle, a frame, a ring, a stand, or a holder.

Support component 14 is manufactured separately from feeding component 12. This will allow for sterilization of the unitized pre-packaged animal food 26 contained in feeding component 12 without the need to sterilize support component 14. As a result, it is not necessary to construct support component 14 from retort grade material. As one might expect, the cost of retort grade materials is higher than that of most non-retort grade materials.

The use of feeding component 12, 12A, 12B, 42 and support component 14, 44 in combination completes the overall functional aspect of the multi-piece animal food server 10, 10A. Feeding component 12, 12A, 12B, 42 provides a pre-packaged serving of animal food ready for consumption by a animal. Support component 14, 44 provides a serving base for at least one feeding component 12, 12A, 12B, 42. Feeding component 12, 12A, 12B, 42 and support component 14, 44 can be combined to form the multi-piece animal food server 10, 10A using an array of different methods. Preferably, feeding component 12, 12A, 12B, 42 is combined with support component 14, 44 by a drop-in-place method in which support component 14, 44 holds at least one feeding component 12, as illustrated in FIGS. 4A and 4B. This is the simplest, most convenient and economic method. However, other methods such as clip-in-place, snap-in-place, friction fit, the use of adhesives, welds, magnets, Velcro and wax can be used in which support component 14, 44 holds and engages at least one feeding component 12, 12A, 12B, 42.

The present invention is directed to a simple, fast and convenient method of feeding an animal that requires minimal effort by the animal owner. The method allows an animal owner to have minimal, if any, contact with the animal food. It eliminates the need to transfer animal food to an animal's bowl and to wash the animal's bowl after each use.

According to the preferred embodiment of the present invention, an animal owner takes container 12, 12A, 12B, 42 which contains a unitary pre-packaged serving of animal food 26 from its storage location and inserts the container 12, 12A 12B into opening 38 of support component 14 and container 42 into the indented portion 46 of support component 44. The animal owner can remove the cover or seal 28, 28A, 28B, 56 of container 12, 12A, 12B, 42 to expose animal food 26 contained within cavity 22, 22A, 22B either before or after inserting the container 12, 12A, 12B, 42 into the support component 14, 44. After the animal has finished feeding, the animal owner simply removes the empty or partially empty container 12, 12A 12B, 42 from support component 14, 44 and disposes the container 12, 12A, 12B, 42. Support component 14, 44 can be kept and reused as many times as the animal owner desires. The support component 14, 44 allows the feeding component 12, 12A, 12B, 42 to be disposed of without touching by or direct interaction with the owner's hands, by inverting the feeding component 12, 12A, 12B, 42 and ejecting it from the support component 14, 44.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein can be utilized according to the present invention. Accordingly, the appended claims are intended to include within their scope such processes, machines, manufacture, compositions of matter, means, methods, or steps.

What is claimed is:

1. A multi-piece animal food server comprising:
a feeding component, the feeding component comprising a unitary pre-packaged serving of animal food in a feeding chamber having a removable cover; and
a support component, the support component being configured so that the feeding component can be removably placed therein, wherein the feeding and support components are separate components.

2. The animal food server of claim 1, wherein the feeding component has a bottom and one or more side walls including a top edge and a bottom edge, wherein the bottom edge of the one or more side walls is connected to a perimeter of the bottom forming a feeding surface.

3. The animal food server of claim 1, wherein the feeding component has a border portion surrounding an outer perimeter of the component and a score line and tab along a top surface of the component for removal of the cover.

4. The animal food server of claim 1, wherein the cover is selected from a group consisting of a peelable film, peelable top portion, removable lid, and a removable, reclosable lid.

5. The animal food server of claim 2, wherein the container further includes a projection extending outwardly from the top edge of the one or more side walls.

6. The animal food server of claim 2, wherein the one or more side walls forms a circular side wall.

7. The animal food server of claim 1, wherein the support component includes one or more side members and a top surface, wherein the top surface includes an opening configured to removably receive the feeding component therein.

8. The animal food server of claim 7, wherein the one or more side members forms a circular side member.

9. The animal food server of claim 8, wherein the circular side member extends downwardly and outwardly from the top surface.

10. The animal food server of claim 7, wherein the support component further includes an indented area on its top surface for receiving a portion of the feeding component.

11. The animal food server of claim 1, wherein the feeding component has a bottom component generally in the shape of a plate and a cover that is generally dome shaped.

12. The animal food service of claim 11, wherein the cover includes a peelable seal over its opening.

13. The animal food server of claim 1, wherein the support component is generally rectangular in shape, includes an indentation configured to hold the food component and a leg at each corner of the support component

14. The animal food server of claim 13, wherein the support component further includes a pair of clip members positioned along two opposing and parallel sides of support

15. The animal food server of claim 1, wherein the support component is further configured to engage the feeding component.

16. A method for feeding a animal, the method comprising:
providing a feeding component containing a unitary pre-packaged serving of animal food in a feeding chamber with a removable cover;
providing a support component configured so that the feeding component can be removably placed therein; and
placing the feeding component in the support component for consumption by a animal.

17. The method of claim 16, wherein the feeding component is opened either prior to or after placing the feeding component into the support component.

18. The method of claim 16, wherein the support component includes a support base having one or more side members and a top surface and the top surface includes an opening configured to removably receive the feeding component therein.

19. The method of claim 16, wherein the cover is selected from a group consisting of a peelable film, peelable top portion, removable lid, and a removable, reclosable lid.
